(19) United States
(12) Patent Application Publication
(10) Pub. No.: US 2025/0126238 A1
(43) Pub. Date: Apr. 17, 2025

(54) VIDEO PROCESSING APPARATUS, VIDEO PROCESSING METHOD, AND PROGRAM

(71) Applicant: NIPPON TELEGRAPH AND TELEPHONE CORPORATION, Tokyo (JP)

(72) Inventors: Motohiro MAKIGUCHI, Musashino-shi, Tokyo (JP); Taiki FUKIAGE, Musashino-shi, Tokyo (JP); Takashi SANO, Musashino-shi, Tokyo (JP); Hitoshi SESHIMO, Musashino-shi, Tokyo (JP)

(73) Assignee: NIPPON TELEGRAPH AND TELEPHONE CORPORATION, Tokyo (JP)

(21) Appl. No.: 18/686,464

(22) PCT Filed: Sep. 6, 2021
(86) PCT No.: PCT/JP2021/032695

§ 371 Date: Feb. 26, 2024

(51) Int. Cl. H04N 13/122; H04N 13/156; H04N 13/383

(52) U.S. Cl. CPC H04N 13/122; H04N 13/156; H04N 13/383

(57) ABSTRACT

An image processing device according to an embodiment generates a stereoscopic image presented to a plurality of users from an original image. The image processing device is a computer including a processor. The processor is configured to: discretely divide an assumed viewpoint position of a tracked user who is a main viewer of the stereoscopic image; acquire an actual viewpoint position of the tracked user; generate left and right parallax inducing patterns from viewpoint images obtained by capturing an object included in the original image from a plurality of viewpoint positions, with a viewpoint image at the actual viewpoint position as a reference; and generate a stereo pair image including an image obtained by adding the parallax inducing patterns to a reference image to be presented and an image obtained by subtracting the parallax inducing patterns from the reference image.

### TECHNICAL FIELD

Embodiments of the present invention relate to a technique for generating a stereoscopic image,

### BACKGROUND ART

In recent years, studies have been actively conducted on generation of stereoscopic images, also referred to as stereo images. For example, eye-gaze tracking naked-eye three-dimensional (3D) displays are known (see Non Patent Literature 1). This technology attempts to present a stereoscopic image (3D image) with high resolution by tracking positions of both eyes in the recognized user's face including a depth direction, and optimizing and presenting a stereo image with a lenticular or parallax barrier in accordance with both eye positions.

Generally, since a lenticular or parallax barrier naked-eye 3D display displays a plurality of viewpoint images in a space in a divided manner, the resolution is lower according to the number of viewpoints. On the other hand, an eye-gaze tracking 3D display can present an image with high resolution since pixels are replaced in real time only with the viewpoint images of the left and right eyes of a single user.

Meanwhile, the image presented by the eye-gaze tracking naked-eye 3D display is optimized only for a user being tracked (hereinafter referred to as a “tracked user”) who is a main viewer of the stereoscopic image. Therefore, the viewpoint image is not completely separated at a viewpoint position of another user (hereinafter referred to as an “untracked user”), and a ghost such as a double image is observed. HiddenStereo can be a promising countermeasure.

### CITATION LIST

### Non Patent Literature

Non Patent Literature 1: “Attouteki na jitsuzaikan ragan de tanoshimu 3D eizou kuukan saigen display “ELF-SR1” (in Japanese) (Overwhelming Sense of Reality, 3D Image Enjoyed with Naked Eyes, 3D Spatial Reality Display “ELF-SR1”), Press Release”, SONY, 2020/10, [online], [searched on Aug. 6, 2021], Internet <URL: https://www.sony.jp/CorporateCruise/Press/202010/20-1016/>

### SUMMARY OF INVENTION

### Technical Problem

HiddenStereo is a technology for “generating a stereo image by which a 2D image is clearly viewed by a viewer not wearing 3D glasses and a 3D image is shown to a viewer wearing 3D glasses”. By displaying a stereo image created by HiddenStereo with basic viewpoint images, it is possible to display a two-dimensional (2D) image without ghosts for untracked users. However, in this case, motion parallax due to viewpoint movement of a tracked user cannot be reproduced.

The present invention has been made to address the problems above, and an object of the present invention is to provide a technology capable of both presenting a stereoscopic image including motion parallax to a tracked user and presenting a ghost-free image to an untracked user.

### Solution to Problem

An image processing device according to one embodiment of the present invention generates a stereoscopic image presented to a plurality of users from an original image. The image processing device is a computer including a processor. The processor is configured to: discretely divide an assumed viewpoint position of a tracked user who is a main viewer of the stereoscopic image; acquire an actual viewpoint position of the tracked user; generate left and right parallax inducing patterns from viewpoint images obtained by capturing an object included in the original image from a plurality of viewpoint positions, with a viewpoint image at the actual viewpoint position as a reference; and generate a stereo pair image including an image obtained by adding the parallax inducing patterns to a reference image to be presented and an image obtained by subtracting the parallax inducing patterns from the reference image.

### Advantageous Effects of Invention

According to one aspect of the present invention, it is possible to provide an image processing device, an image processing method and a program, each capable of both presenting a stereoscopic image including motion parallax to a tracked user and presenting a ghost-free image to an untracked user.

### BRIEF DESCRIPTION OF DRAWINGS

FIG. 1 is a block diagram illustrating one example of an image processing device according to an embodiment.

FIG. 2 is a diagram illustrating an example in which an assumed viewpoint position of a tracked user is discretely divided.

FIG. 3 is a diagram illustrating generation of a stereo pair image corresponding to a viewpoint position “Center”.

FIG. 4 is a diagram illustrating generation of a stereo pair image corresponding to a viewpoint position “L1”.

FIG. 5 is a diagram illustrating generation of a stereo pair image corresponding to a viewpoint position “R1”.

FIG. 6 is a diagram illustrating one example of parallax induction in the embodiment.

FIG. 7 is a diagram illustrating one example of parallax induction obtained by a conventional technology for comparison.

FIG. 8 is a diagram illustrating a method of reproducing motion parallax in a third embodiment.

### DESCRIPTION OF EMBODIMENTS

Hereinafter, an embodiment according to the present invention will be described with reference to the drawings.

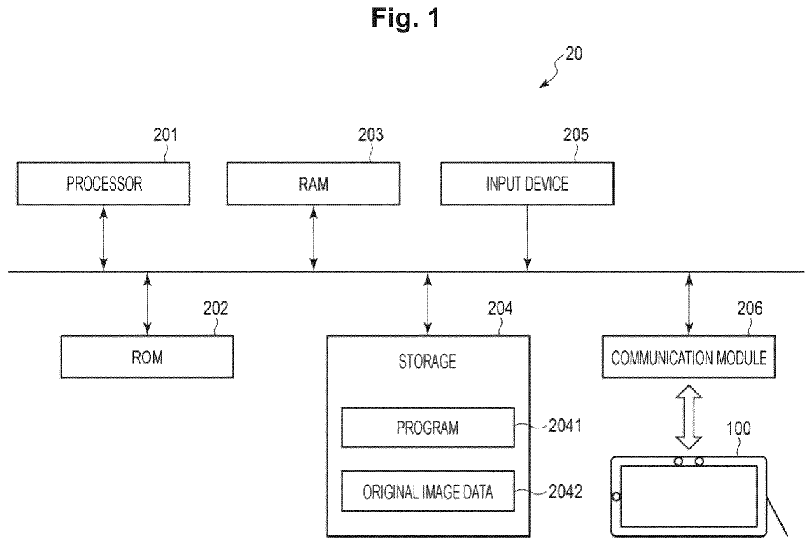

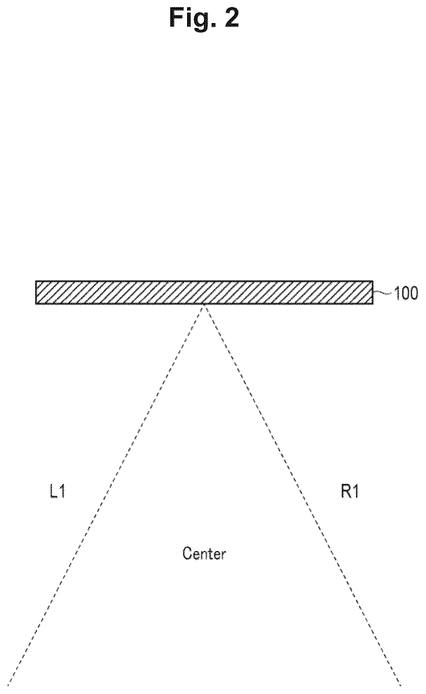

FIG. 1 is a block diagram illustrating one example of an image processing device according to an embodiment. An image processing device 20 of the embodiment can be configured as a computer. The image processing device 20 does not need to be a single computer, and may include a plurality of computers. As illustrated in FIG. 2, the image processing device 20 includes a processor 201, a read only memory (ROM) 202, a random access memory (RAM) 203, a storage 204, an input device 205, and a communication module 206. The image processing device 20 may further include a display and the like.

The processor 201 is a processing circuit capable of executing various programs and controls the entire operation of the image processing device 20. The processor 201 may be a processor such as a central processing unit (CPU), a micro processing unit (MPU), or a graphics processing unit (GPU). Also, the processor 201 may be an application specific integrated circuit (ASIC), a field programmable gate array (FPGA), or the like. For example, the processor 201 may include a single CPU, or may include a plurality of CPUs.

The ROM 202 is a nonvolatile semiconductor memory, and holds programs, control data, and the like for controlling the image processing device 20.

The RAM 203 is, for example, a volatile semiconductor memory, and is used as a working area of the processor 201.

The storage 204 is a nonvolatile storage device such as a hard disk drive (HDD) or a solid state drive (SSD). The storage 204 holds a program 2041 and original image data 2042.

The program 2041 is a program for processing the original image data 2042 to generate a three-dimensional (3D) image. The program 2041 is a program for causing the processor 201 to execute processing of: discretely dividing an assumed viewpoint position of a tracked user who is a main viewer of the stereoscopic image; acquiring an actual viewpoint position of the tracked user; generating left and right parallax inducing patterns from viewpoint images obtained by capturing an object included in the original image from a plurality of viewpoint positions, with a viewpoint image at the actual viewpoint position as a reference; and generating a stereo pair image including an image obtained by adding the parallax inducing patterns to a reference image to be presented and an image obtained by subtracting the parallax inducing patterns from the reference image.

The input device 205 is an interface device for an administrator of the image processing device 20 to operate the image processing device 20. The input device 205 may include, for example, a touch panel, a keyboard, a mouse, various operation buttons, and various operation switches. The input device 205 can be used to input the original image data 2042, for example.

The communication module 206 is a module including a circuit used for communication between the image processing device 20 and a 3D display 100. The communication module 206 may be, for example, a communication module conforming to a standard of a wired LAN. The communication module 206 may be, for example, a communication module conforming to a protocol of a wireless LAN.

FIG. 2 is a diagram illustrating an example in which an assumed viewpoint position of a tracked user is discretely divided. FIG. 2 illustrates the 3D display 100 from above. For example, the viewpoint position for the 3D display 100 can be divided into “Center” at the center of the visual field and the left and right regions thereof, “L1” and “R1”, respectively. The assumed viewpoint position can be surely further divided into a larger number of regions. For example, it is possible to set one Center; three regions of L1, L2, and 13 on the left side; and three other regions of R1, R2, and R3 on the right side,

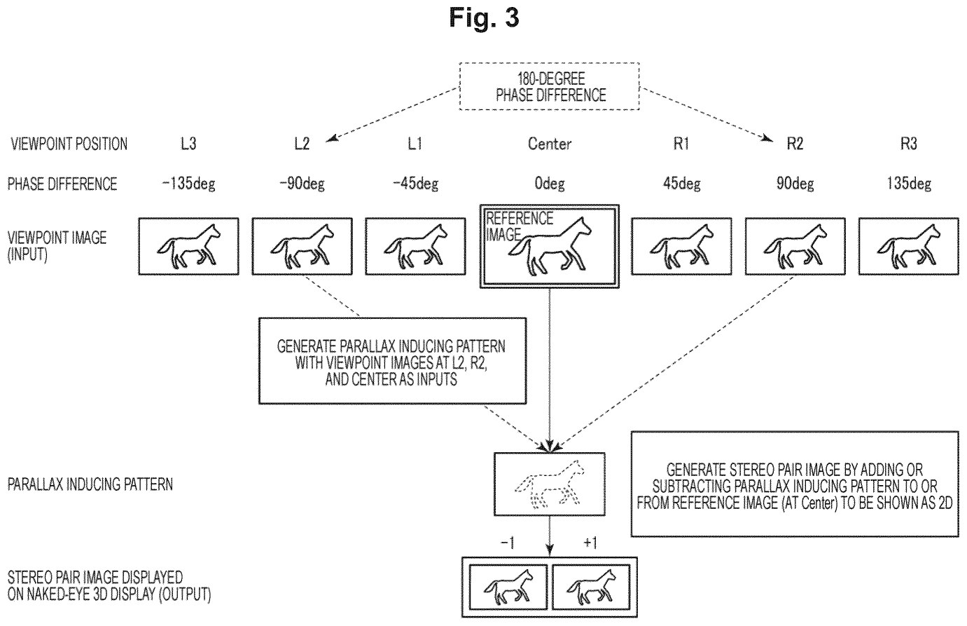

FIG. 3 is a diagram illustrating generation of a stereo pair image corresponding to the viewpoint position “Center”. Processing illustrated in FIG. 3 is similar to the known processing of HiddenStereo. Three viewpoint images obtained by capturing a target 3D object from a plurality of viewpoint positions are input to the left and right sides of a reference image at the Center. A phase difference for the reference image is incremented by 45 degrees toward the right side, and decremented by 45 degrees toward the left side.

For example, a parallax inducing pattern can be generated using the viewpoint images at L2 and R2 having a phase difference of 180 degrees and the viewpoint image at Center as inputs. A stereo pair image including an image (+1) obtained by adding the parallax inducing pattern to the reference image (Center) to be presented and an image (−1) obtained by subtracting the parallax inducing pattern from the reference image is generated.

The stereo pair image generated in this manner is output when the viewpoint position of the tracked user is at Center. Accordingly, the tracked user can perceive the stereo pair image as a 3D image. However, it is difficult to reproduce the motion parallax with this processing alone. An embodiment in which the motion parallax for the tracked user can be reproduced will be described below.

### First Embodiment

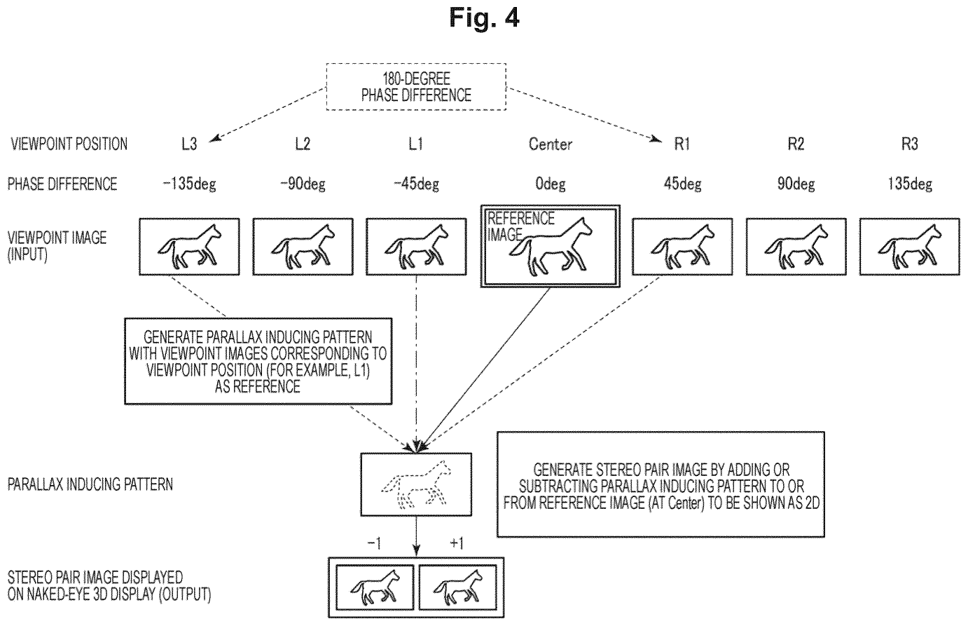

FIG. 4 is a diagram illustrating generation of a stereo pair image corresponding to the viewpoint position “L1”. The processor 201 discretely divides the assumed viewpoint position of the user, generates a HiddenStereo pair image having motion parallax corresponding to each viewpoint position on the basis of viewpoint images obtained by capturing a 3D object to be displayed from a plurality of viewpoint positions, and holds the generated image in the storage 204, for example.

The processor 201 then detects the viewpoint position of the tracked user and determines an assumed viewpoint position corresponding to the viewpoint position. In FIG. 4, it is assumed that the viewpoint position is detected at the position L1. The processor 201 reads a HiddenStereo pair image corresponding to the assumed viewpoint position from the storage 204 and outputs the same.

In FIG. 4, a parallax inducing pattern is generated, in which a viewpoint image 11 at the viewpoint position L1 and viewpoint images L3 and R1 having a phase difference of 180 degrees for the viewpoint image L1 are used as inputs. A stereo pair image including an image (+1) obtained by adding the parallax inducing pattern to the reference image (Center) to be presented and an image (−1) obtained by subtracting the parallax inducing pattern from the reference image is generated.

The stereo pair image generated in this manner is output when the viewpoint position of the tracked user is at 11. Accordingly, the tracked user can perceive the stereo pair image as a 3D image even at the viewpoint position 11. That is, the stereo pair image corresponding to the viewpoint position L1 can be generated (left-right asymmetric parallax induction).

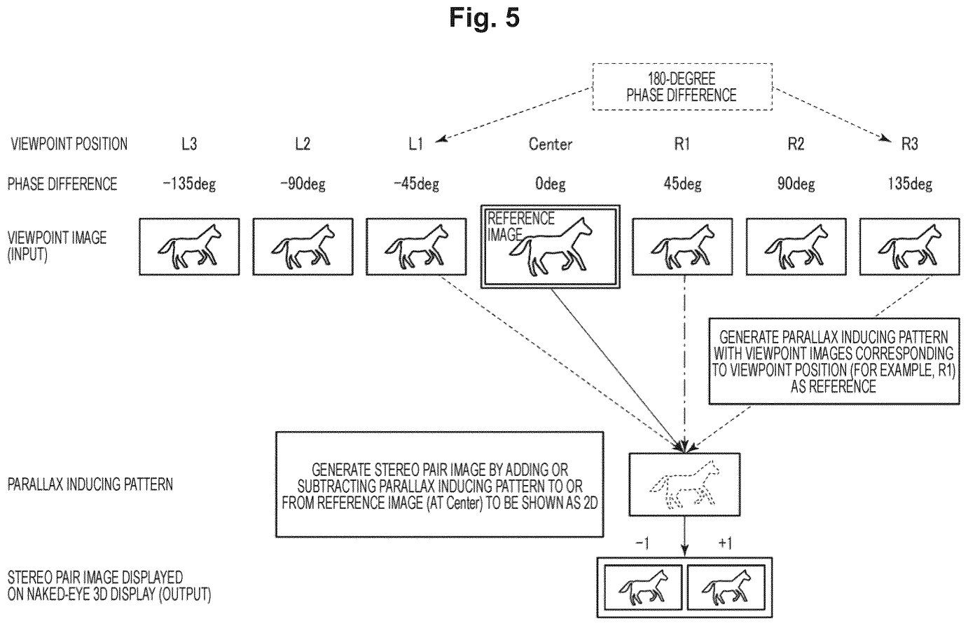

FIG. 5 is a diagram illustrating generation of a stereo pair image corresponding to the viewpoint position “R1”. In FIG. 5, a parallax inducing pattern is generated, in which a viewpoint image R1 at the viewpoint position R1 and viewpoint images L1 and R3 having a phase difference of 180 degrees for the viewpoint image R1 are used as inputs. A stereo pair image including an image (+1) obtained by adding the parallax inducing pattern to the reference image (Center) to be presented and an image (−1) obtained by subtracting the parallax inducing pattern from the reference image is generated.

The stereo pair image generated in this manner is output when the viewpoint position of the tracked user is at R1. Accordingly, the tracked user can perceive the stereo pair image as a 3D image even at the viewpoint position R1. That is, the stereo pair image corresponding to the viewpoint position R1 can be generated. Furthermore, it is possible to enable reproduction of the motion parallax by the parallax inducing pattern corresponding to the viewpoint position by similarly generating images for other viewpoints and switching the stereo pair image to be output in accordance with the viewpoint position of the tracked user.

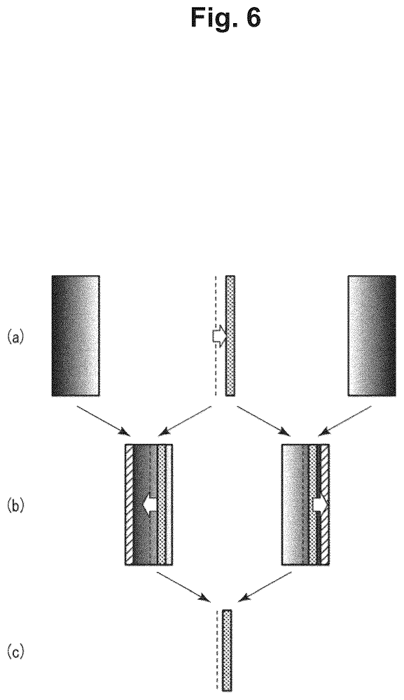

FIG. 6 is a diagram illustrating one example of parallax induction in the embodiment. In the embodiment, a left-right asymmetric parallax inducing pattern is generated.

In FIG. 6(a), the L1-based parallax inducing pattern (−), an edge of the reference image (Center), and the L1-based parallax inducing pattern (+) are illustrated in order from the left. It is assumed that the edge of the reference image (Center) is closer to the right side by 45 [deg] than an edge of L1.

As illustrated in FIG. 6(b), a left-eye image is generated by combining the L1-based parallax inducing pattern (−) and the edge of the reference image (Center). A right-eye image is generated by combining the edge of the reference image (Center) and the L1-based parallax inducing pattern (+). The edge is induced in the left-eye image, and a viewpoint image in a L3-direction (Center−135 [deg]) is perceived. The edge is induced in the right-eye image, and a viewpoint image in a R1-direction (Center+45 [deg]) is perceived.

As illustrated in FIG. 6(c), when the left and right viewpoint images are combined, the parallax inducing pattern is canceled, and only the edge of Center is perceived. The processor 201 may be provided with adjustment function capable of shifting a pair of viewpoint images for creating the parallax inducing pattern or additionally widening the parallax interval so that edge perception of the reference image is made at a desired position.

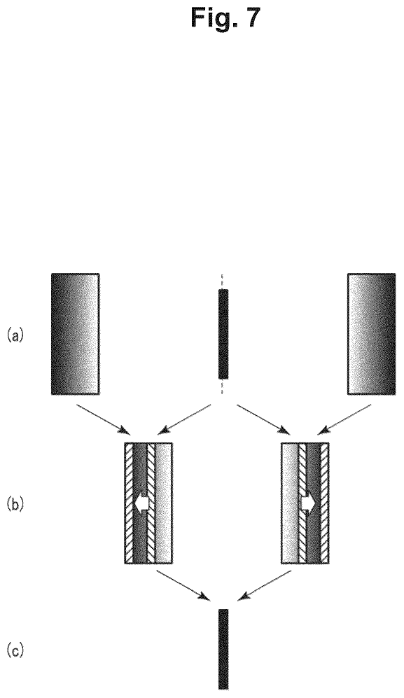

FIG. 7 is a diagram illustrating one example of parallax induction obtained by a conventional technology for comparison. Conventional HiddenStereo generates a bilaterally symmetric parallax inducing pattern.

In FIG. 7(a), the L1-based parallax inducing pattern (−), an edge of the viewpoint image 11, and the L1-based parallax inducing pattern (+) are illustrated in order from the left.

As illustrated in FIG. 7(b), a left-eye image is generated by combining the L1-based parallax inducing pattern (−) and the edge of the viewpoint image L1. A right-eye image is generated by combining the edge of the viewpoint image 11 and the L1-based parallax inducing pattern (+). The edge is induced in the left-eye image, and a viewpoint image corresponding to L3 (L1−90 [deg]) is perceived. The edge is induced in the right-eye image, and a viewpoint image corresponding to R1 (L1+90 [deg]) is perceived.

As illustrated in FIG. 7(c), when the left and right viewpoint images are combined, the parallax inducing pattern is canceled, and only the edge of L1 is perceived.

In the embodiment as described above, it is possible to enable reproduction of the motion parallax by the parallax inducing pattern corresponding to the viewpoint position by generating the left-right asymmetric parallax inducing pattern and switching the stereo pair image to be output in accordance with the viewpoint position of the tracked user. That is, according to the embodiment, the 3D image including motion parallax due to viewpoint movement can be presented to the tracked user, and the ghost-free 2D image (reference image) can be presented to the untracked user. In other word, according to the embodiment, it is possible to provide the image processing device, the image processing method and the program, each capable of both presenting a stereoscopic image including motion parallax to a tracked user and presenting a ghost-free image to an untracked user.

### Second Embodiment

A second embodiment discloses a method of generating a stereo pair image different from that of the first embodiment. In particular, optimization of a phase shift amount will be described. For example, three viewpoint images at 13, Center, and R1 may be used as inputs without using the viewpoint image L1 as an input, and a stereo pair image in which the phase shift amount is optimized may be generated by the following procedure.

A phase of the viewpoint image Center is denoted by x, a phase of the viewpoint image L3 is denoted by l_3, a phase of the viewpoint image R1 is denoted by r_1, a phase shift amount (and orientation) of the parallax inducing pattern to be obtained is denoted by y, and an amplitude is denoted by A.

A phase shift amount (and orientation) z after the parallax inducing pattern is added is expressed by Equation (1).

$$[ Math . 1 ]$$

$$sin ( x ) + A sin ( x + y ) = B sin ( x + z ) , \qquad ( 1 )$$

$$z - arctan \{ A sin ( y ) / ( 1 + A cos ( y ) ) \} + 0 ( if 1 + A cos ( y ) >= 0 )$$

$$z - arctan \{ A sin ( y ) / ( 1 + A cos ( y ) ) \} + pi ( if 1 + A cos ( y ) < 0 )$$

A phase shift amount (and orientation) z′ after the parallax inducing pattern is subtracted is expressed by Equation (2).

$$[ Math . 2 ]$$

$$sin ( x ) + A sin ( x + y ) = {B}^{′} sin ( x + {z}^{′} ) , \qquad ( 2 )$$

$${z}^{′} - arctan \{ - A sin ( y ) / ( 1 + A cos y ) ) + 0 ( if 1 - A cos ( y ) >= 0 )$$

$${z}^{′} - arctan \{ - A sin ( y ) / ( 1 + A cos y ) ) + pi ( if 1 - A cos ( y ) < 0 )$$

A set of (A, y) that minimizes a solution of Equation (3) is obtained by the full search.

$$[ Math . 3 ]$$

$$N = {\vert z - ( I\_ 3 - x ) \vert}^{2} + {\vert {z}^{′} - ( r\_ 1 - x ) \vert}^{2} \qquad ( 3 )$$

Furthermore, an optimal set (A, y) is obtained by the above procedure for each frequency component in the image. According to this procedure, it is possible to present a stereoscopic image including motion parallax to a tracked user and a ghost-free image to an untracked user, while optimizing the phase shift amount.

### Third Embodiment

In a third embodiment, reproduction of motion parallax by HiddenStereo presentation corresponding to the viewpoint position will be described.

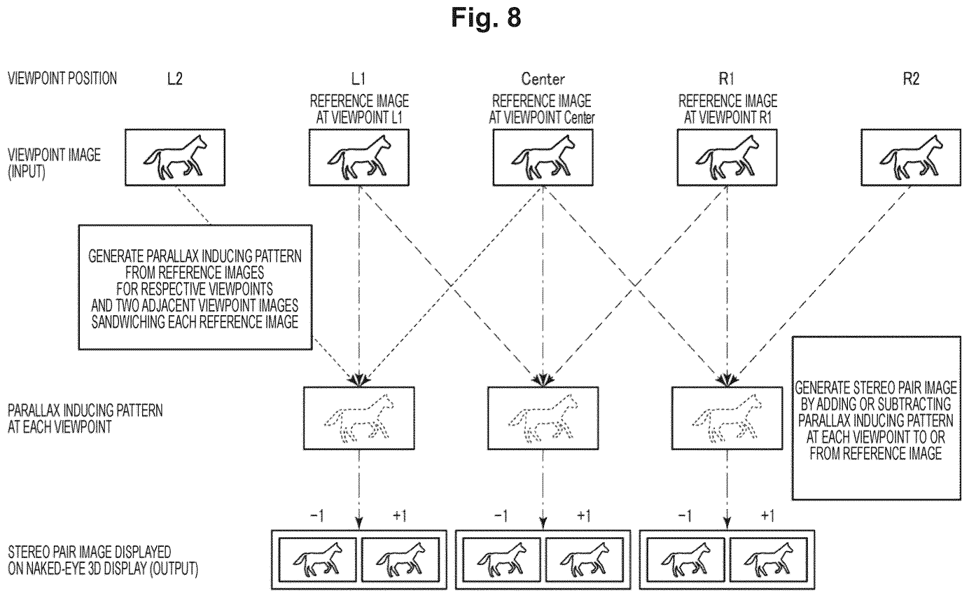

FIG. 8 is a diagram illustrating a method of reproducing motion parallax in the third embodiment. In FIG. 8, HiddenStereo images corresponding to the assumed viewpoint position are generated, switched and presented in accordance with the viewpoint position of the tracked user; it is thus possible to make the untracked user perceive the ghost-free 2D image (reference image) while reproducing the motion parallax. At this time, the processor 201 switches the reference image according to the viewpoint movement of the tracked user.

In FIG. 8, a parallax inducing pattern is generated, based on the reference image at the viewpoint L1, the reference image at the viewpoint Center, and the reference image of at viewpoint R1, from the reference images of the respective viewpoints and two adjacent viewpoint images sandwiching each reference image. Additionally, a stereo pair image is generated by adding or subtracting the parallax inducing pattern of each viewpoint position to or from the reference image. The stereo pair image to be output is switched in accordance with the viewpoint position of the tracked user. In this way, the 3D image viewed by the tracked user can be shared with the untracked user as a ghost-free 2D image.

As described above, according to the respective embodiments, it is possible to provide the image processing device, the image processing method and the program, each capable of both presenting a stereoscopic image including motion parallax to a tracked user and presenting a ghost-free image to an untracked user.

The program for performing the above processes may be stored in a computer-readable recording medium (or a storage medium) to be provided. The program is stored in a recording medium as a file in an installable format or a file in an executable format. Examples of the recording medium include a magnetic disk, an optical disk (such as a CD-ROM, a CD-R, a DVD-ROM, or a DVD-R), a magneto-optical disk (such as an MO), and a semiconductor memory. Alternatively, the program for performing the above processes may be stored in a computer (a server) connected to a network such as the Internet, and be downloaded into a Computer (a client) via the network.

The image processing device according to the embodiment can construct an operation of each component as a program, install the program into a computer that is used as the image processing device, and cause the program to be executed or distribute the program via a network. The present invention is not limited to the above embodiment, and various modifications and applications are possible.

In short, this invention is not limited to the above embodiments, and various modifications can be made in the implementation stage without departing from the scope thereof. Further, embodiments may be implemented in an appropriate combination, and, in that case, effects as a result of the combination can be achieved. Moreover, the above embodiments include various types of inventions, and various types of inventions can be extracted by a combination selected from a plurality of disclosed components. For example, even if some components are eliminated from all the components described in the embodiment, a configuration from which the components are eliminated can be extracted as an invention in a case where the problem can be solved and the advantageous effects can be obtained.

### REFERENCE SIGNS LIST

20 Image processing device
100 Display
201 Processor
202 ROM
203 RAM
204 Storage
205 Input device
206 Communication module
2041 Program
2042 Original image data

1. An image processing device for generating a stereoscopic image presented to a plurality of users from an original image, the device comprising:
a first memory to store a program;
a second memory in which the program is loaded from the first memory; and
a processor, connected to the second memory, configured to process information in accordance with an instruction described in the program loaded in the second memory,
wherein the processor is further configured to:
discretely divide an assumed viewpoint position of a tracked user who is a main viewer of the stereoscopic image;
acquire an actual viewpoint position of the tracked user;
generate left and right parallax inducing patterns from viewpoint images obtained by capturing an object included in the original image from a plurality of viewpoint positions, with a viewpoint image at the actual viewpoint position as a reference; and
generate a stereo pair image including an image obtained by adding the parallax inducing patterns to a reference image to be presented and an image obtained by subtracting the parallax inducing patterns from the reference image.

2. The image processing device according to claim 1, wherein;
the processor is configured to adjust positions of a pair of viewpoint images used for generating the parallax inducing patterns to set edge perception of the reference image at a desired position.

3. The image processing device according to claim 1, wherein:
the processor is configured to adjust a parallax interval of a pair of viewpoint images used for generating the parallax inducing patterns to set edge perception of the reference image at a desired position.

4. The image processing device according to claim 1, wherein:
the processor is configured to optimize a phase shift amount of the stereo pair image.

5. The image processing device according to claim 1, wherein;
the processor is configured to create a stereo image for each of the assumed viewpoint positions, and switch the stereo images to present the stereo image in accordance with a viewpoint position of the tracked user.

6. An image processing method for generating a stereoscopic image presented to a plurality of users from an original image by a computer, wherein the computer includes a first memory to store a program, a second memory in which the program is loaded from the first memory, and a processor configured to process information in accordance with an instruction described in the program loaded in the second memory, the method comprising:
discretely dividing, by the processor, an assumed viewpoint position of a tracked user who is a main viewer of the stereoscopic image;
acquiring, by the processor, an actual viewpoint position of the tracked user;
generating, by the processor, left and right parallax inducing patterns from viewpoint images obtained by capturing an object included in the original image from a plurality of viewpoint positions, with a viewpoint image at the actual viewpoint position as a reference; and
generating, by the processor, a stereo pair image including an image obtained by adding the parallax inducing patterns to a reference image to be presented and an image obtained by subtracting the parallax inducing patterns from the reference image.

7. A non-transitory computer readable medium storing a program for causing a computer to perform the method of claim 6.
